(19) United States
(12) Patent Application Publication
(10) Pub. No.: US 2020/0379786 A1
(43) Pub. Date: Dec. 3, 2020

(54) KEYBOARD INTERACTION MODEL FOR SOFTWARE BUILDER CANVAS NODES

(71) Applicant: salesforce.com, inc., San Francisco, CA (US)

(72) Inventors: Donielle Berg, San Francisco, CA (US); Lee White, San Francisco, CA (US)

(21) Appl. No.: 16/430,090

(22) Filed: Jun. 3, 2019

(51) Int. Cl. G06F 9/451; G06F 3/0481; G06F 3/0482; G06F 17/24

(52) U.S. Cl. CPC G06F 9/453; G06F 17/24; G06F 3/0482; G06F 3/04817

(57) ABSTRACT

A system and method for navigating a modeling canvas used in software development accesses the modeling canvas at a starting active cell containing a node. The modeling canvas contains a grid pattern arranged in rows and columns of cells. Keyboard initiated control commands are received and executed to indicate and select a new active cell containing a node. An aural signal is generated with a screen reader in response to the selection of the new active cell. The aural signal communicates the contents of a label of the node within the new active cell to a user.

### TECHNICAL FIELD

Embodiments of the subject matter described herein relate generally to software development tools. More particularly, embodiments of the subject matter relate to a keyboard interaction model for software builder canvas nodes.

### BACKGROUND

Software developers a builder or modeling canvas is a piece of software that is used to map out different processes. However, a user typically uses the modeling canvas with a computer mouse and a “drag and drop” technique for exploring or editing the canvas. This is a disadvantage to someone who is visually impaired or to someone who prefers to use a keyboard instead of a mouse. Accordingly, it is desirable to provide a keyboard interaction model for software builder canvas nodes. Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a depiction of a screen image for a software builder canvas and toolbox in accordance with one embodiment;

FIG. 2 is a detailed depiction of a software builder canvas as shown previously in FIG. 1 in accordance with one embodiment;

FIG. 3 is a detailed depiction of a software builder toolbox as shown previously in FIG. 1 in accordance with one embodiment;

FIG. 4 is a depiction of a grid for a software builder canvas in accordance with one embodiment; and

FIG. 5 shows an example of a multi-tenant system based upon data from a database that may be shared between multiple tenants in accordance with one embodiment.

### DETAILED DESCRIPTION

A method and apparatus for navigating a modeling canvas used in software development has been developed. The modeling canvas contains a grid pattern arranged in rows and columns of cells. Each cell contains a node, with one active cell at any time. A keyboard-initiated control command is received and executed to indicate the selection of a new active cell containing a node. In response to the selection of the new active cell, a screen reader will generate an oral signal that communicates the contents of a label of the node within the new active cell to a user.

As used herein, a “grid” is a set of connected nodes that are located in “cells” that are arranged in rows and columns. The layout is similar to a conventional spreadsheet software application. A “node” is a main button or “node entity” and it is used for any associated actions like create a new node, update, delete. The nodes are arranged in a network that ideally structures the information of the nodes in a way for a user to easily understand.

If a node is not connected to any other node, the separate node is considered to be its own grid. A node contains a main button identifying the “node entity”. A “jump-to menu” is a menu of all the nodes connected to the presently active node. The menu moves the user to the new node that is selected. A “connect-to menu” is a menu of all the nodes that the current active node may be connected to. This menu may be used in place of a conventional drag-and-drop function.

A “modeling canvas” is a visual template used to organize flows by designing, mapping the process. It is sometimes also called a “builder canvas” with a “builder” being all of the grids. Consequently, it should be understood that the terms “builder canvas” and “modeling canvas” may be used interchangeably hereafter.

A “screen reader” is a software application that enables people who are blind or low vision or other disabilities to use a computer. Screen readers convert digital text into synthesized speech. They empower users to hear content and navigate with the keyboard. The technology helps people who are blind or low vision use information technology with the same level of independence and privacy as sighted users. Screen readers are also used by people with certain cognitive or learning disabilities, or users who simply prefer audio content over text. Beyond the internet, screen readers also work with documents, spreadsheets, and the user's operating system. Screen readers work closely with the computer's Operating System (OS) to provide information about icons, menus, dialogue boxes, files and folders. The device provides access to the entire OS that it works with, including many common applications.

The screen reader typically uses a Text-To-Speech (TTS) engine to translate on-screen information into speech, which can be heard through earphones or speakers. A TTS engine may be a software application that comes bundled with the screen reader, or it may be a hardware device that plugs into the computer. Originally, before computers had soundcards, screen readers always used hardware TTS devices, but now that soundcards come as standard on all computers many find that a software TTS is preferable.

Some synthesizer voices are very human sounding, but screen reader users might prefer a more mechanical sounding voice because it is easier to understand at a higher rate of speech. Experienced users can have their rate of speech set to 300 words a minute or more. Depending on what the user is reading, they can update the voice and rate of speech to the best fit.

A screen reader will have a primary language, which matches the language of the operating system. In addition, the readers are capable of dealing with different languages within documents. Since every language has its own pronunciation rules, the screen reader needs to know which language it should “speak.” Web pages specify document language with a “lang” attribute on a tag, in order to encompass the entire document. This facilitates automatic translation of content.

The screen reader presents content linearly to users, one item at a time. This contrasts with the way in which sighted people use visual interfaces. Sighted users can scan an entire screen and gather meaning from visual placement, styles and other macro-level aspects. If information is only presented visually, screen reader users will not be aware of it. Also, since screen readers progress linearly, it is somewhat like automated telephone menu systems which do not reveal all the actions possible at one. Users must progress through these systems in a stepwise manner.

Despite the linear nature of screen readers, they do provide ways for users to navigate content quickly. Since the majority of screen reader users do not use a mouse, there are a variety of keyboard commands. These include, ways to navigate the page by headings, to quickly get the structure or outline. Another related technique is to get a list of all the links on a page. Operating systems also have their own keyboard shortcuts, which are available to everyone not just screen reader users. One example is to use the ‘Tab’ key to move by interactive elements, like links or buttons. This gives the user an idea of where the page links and can be a useful way to run through the content if the user is looking for a specific link. A related technique is to obtain a list of the links on the page, arranged alphabetically.

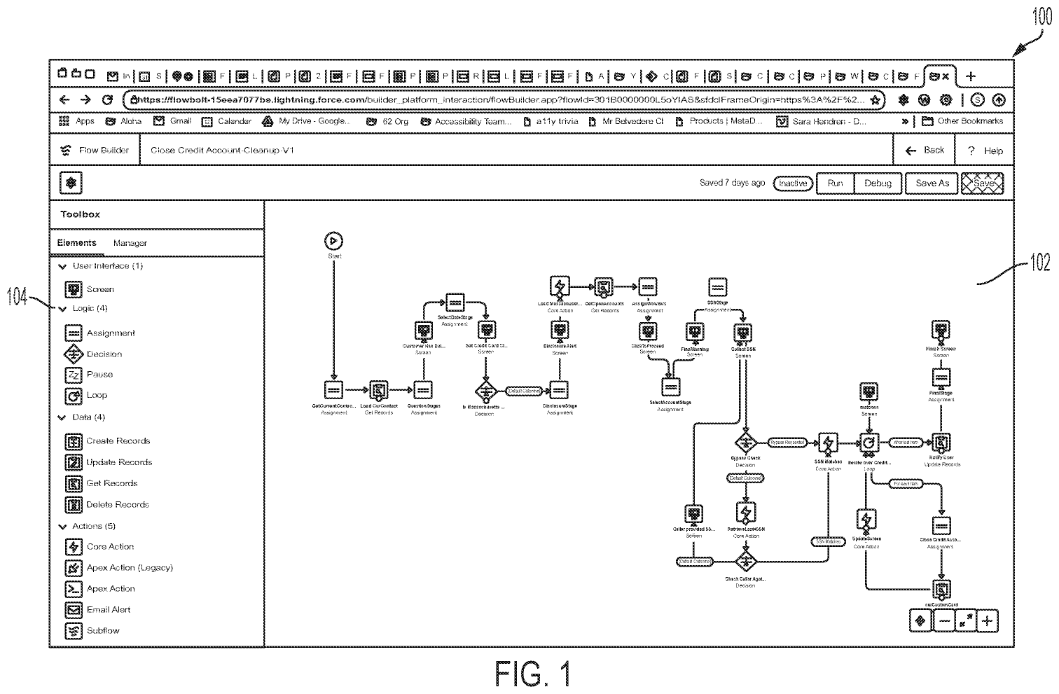

Turning now to FIG. 1, a depiction of a screen image 100 for software builder canvas 102 and toolbox 104 is shown in accordance with one embodiment. In this depiction, the screen image 100 is shown as part of a standard graphical user interface (GUI) with the toolbox 104 located as a side window while the software builder canvas 102 occupies the main area of the screen.

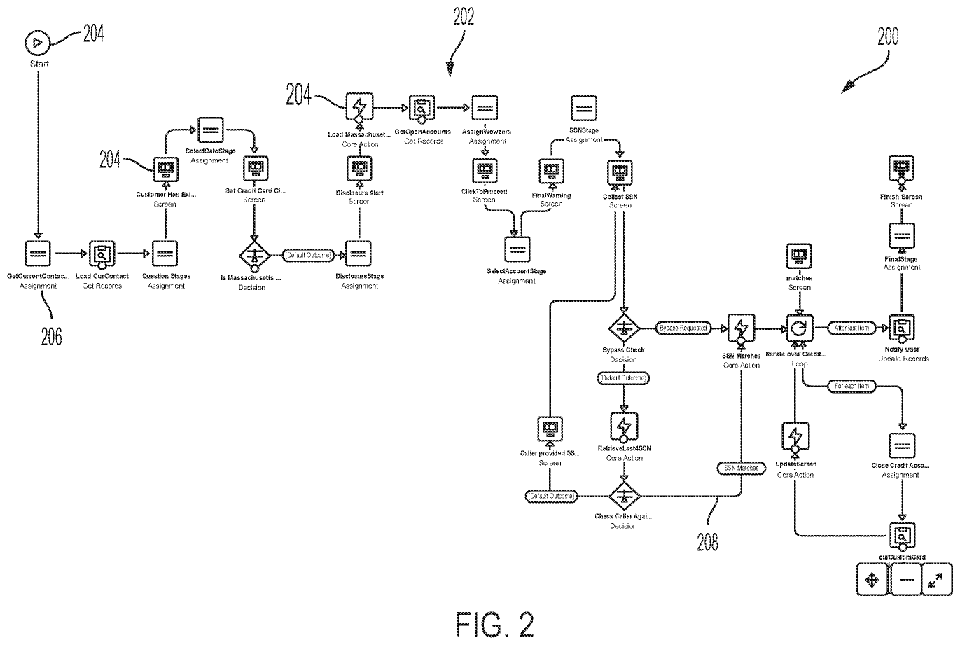

Turning now to FIG. 2, a depiction of a screen image 200 of a software builder canvas 202 as shown previously in FIG. 1 is shown in accordance with one embodiment. The canvas 202 includes multiple levels of nodes 204. The nodes 204 each have a “label” 206 that provide details about the type and name of the node 204 in text form, part of this is visible but there is additional text that is visually hidden meant to help screen reader users. The visually hidden text provides information about what the current node is connected to. Also shown are connecting arrows 208 that show a functional flow pattern between the nodes 204, these are visual only and are not announced by screen readers. Each of the nodes 204 are in a cell of the canvas 202. Each cell with a node may contain an icon button that may be color-coded according to the type of node 204 as well as having a graphical symbol representing the function of the node 204. Additionally, each cell will contain any actions associated with the node, such as delete, edit, and a “jump-to” menu to quickly navigate to other nodes in the modeling canvas 202.

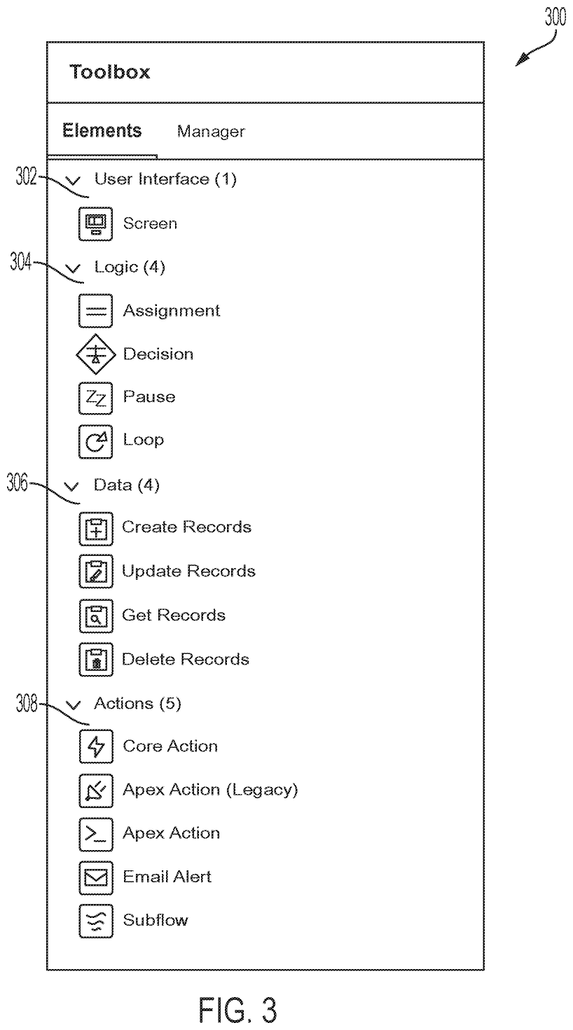

Turning now to FIG. 3, a detailed depiction 300 is shown of a software builder toolbox as shown previously in FIG. 1 in accordance with one embodiment. The toolbox shows a listing of all of the different types of nodes that can be added to the software builder canvas. The nodes are organized by category. In this example, there are four different categories of nodes shown: a user interface node, a logic node, a data node, and an action node. In this canvas, there is one user interface (UI) node, node 302, which is the “screen” type. There are four types of logic nodes: “assignment”, “decision”, “pause”, and “loop”. There are four types of data nodes 306: “create records”, “update records”, “get records”, and “delete records”. These types of nodes provide actions, that when the flow executes, modify stored data or records. Finally, there are five action nodes 308 that are shown with labels of “core action”, “apex action (legacy)”, “apex action”, “email alert”, and “subflow”. The action nodes will execute actions that result from the software flow.

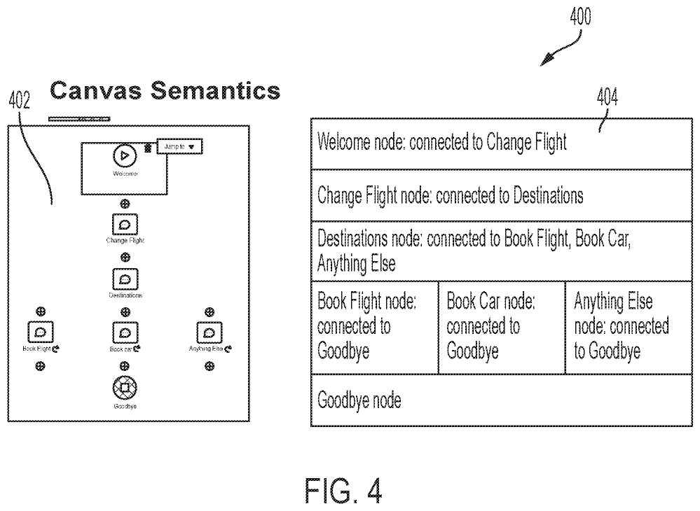

Turning now to FIG. 4, a depiction 400 is shown of a grid equivalent 404 for a software builder canvas 402 in accordance with one embodiment. The node network of the canvas 402 that is shown is similar to the examples shown previously in FIGS. 1 and 2. The grid equivalent 404 is a representation of the textual labels for each cell that the screen reader reads. As shown in the comparison between the canvas 402 and the grid 404, much of the text of the label is visually hidden. Each cell may contain: an icon button; a label; a delete icon; a “plus” button that moves a cursor to the next node; and any other additional actions associated with the node. In this example, the nodes are grouped in rows based on how far they are from the initial node. The nodes represent an example of a software builder canvas for developing software related to airline flight booking software. The nodes are listed as a “welcome” node, a “change flight” node, a “destinations” node, a “book flight” node a “book car” node, and “anything else” node, and a “goodbye” node.

During operation, a user will begin with a initial active cell containing a start node. When the initial cell is selected, the screen reader will generate audio or “aural” signals of the contents of the cell to the user. The aural signals will communicate the entire contents of the label of the node including the visual text as well as the hidden text. In some embodiments, hypertext markup language (HTML) code is used to convey the location and textual information about the node to the screen reader. A user will use a standard keyboard to navigate the canvas. In some embodiments, the user will utilize arrow keys on the keyboard to move between node entities that are arranged in rows and columns. There are two separate navigation modes of operation. The first is a “navigation” mode which authorizes a user to reviewed details of each new active cell. The second mode is a “action” mode which authorizes the user to edit details of each new active cell. The “enter” key may be used to change between navigation and action modes. The “tab” button may be used to open a jump-to-menu or connect-to menu that is used in place of a conventional drop-down menu.

Present embodiments may be developed according to Web Content Accessibility Guidelines (WCAG) 2.0 which defines how to make Web content more accessible to people with disabilities. These guidelines address accessibility for users with a wide range of disabilities including visual, auditory, physical, speech, cognitive, language, learning, and neurological disabilities.

The disclosed embodiments described below may be implemented in a wide variety of different computer-based systems, architectures and platforms which may include a multi-tenant system. Additionally, the disclosed embodiments may be implemented using virtual systems, etc.

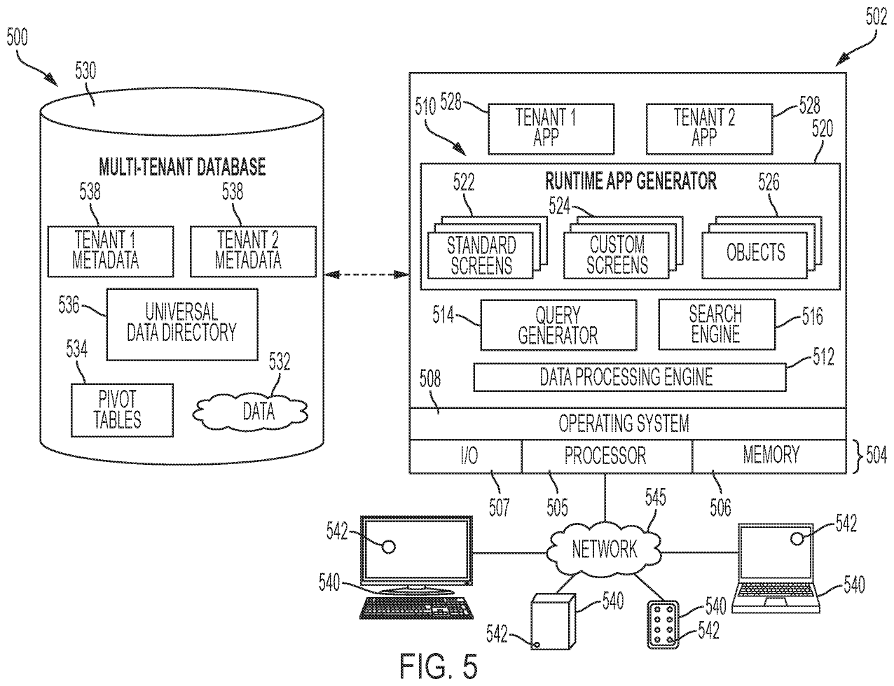

Turning now to FIG. 5, an exemplary multi-tenant system 500 includes a server 502 that dynamically creates and supports virtual applications 528 based upon data 532 from a database 530 that may be shared between multiple tenants, referred to herein as a multi-tenant database. Data and services generated by the virtual applications 528 are provided via a network 545 to any number of client devices 540, as desired. Each virtual application 528 is suitably generated at run-time (or on-demand) using a common application platform 510 that securely provides access to the data 532 in the database 530 for each of the various tenants subscribing to the multi-tenant system 500. In accordance with one non-limiting example, the multi-tenant system 500 is implemented in the form of an on-demand multi-tenant customer relationship management (CRM) system that can support any number of authenticated users of multiple tenants.

As used herein, a “tenant” or an “organization” should be understood as referring to a group of one or more users that shares access to common subset of the data within the multi-tenant database 530. In this regard, each tenant includes one or more users associated with, assigned to, or otherwise belonging to that respective tenant. Stated another way, each respective user within the multi-tenant system 500 is associated with, assigned to, or otherwise belongs to a particular one of the plurality of tenants supported by the multi-tenant system 500. Tenants may represent companies, corporate departments, business or legal organizations, and/or any other entities that maintain data for particular sets of users (such as their respective customers) within the multi-tenant system 500. Although multiple tenants may share access to the server 502 and the database 530, the particular data and services provided from the server 502 to each tenant can be securely isolated from those provided to other tenants. The multi-tenant architecture therefore allows different sets of users to share functionality and hardware resources without necessarily sharing any of the data 532 belonging to or otherwise associated with other tenants.

The multi-tenant database 530 may be a repository or other data storage system capable of storing and managing the data 532 associated with any number of tenants. The database 530 may be implemented using conventional database server hardware. In various embodiments, the database 530 shares processing hardware 504 with the server 502. In other embodiments, the database 530 is implemented using separate physical and/or virtual database server hardware that communicates with the server 502 to perform the various functions described herein. In an exemplary embodiment, the database 530 includes a database management system or other equivalent software capable of determining an optimal query plan for retrieving and providing a particular subset of the data 532 to an instance of virtual application 528 in response to a query initiated or otherwise provided by a virtual application 528, as described in greater detail below. The multi-tenant database 530 may alternatively be referred to herein as an on-demand database, in that the multi-tenant database 530 provides (or is available to provide) data at run-time to on-demand virtual applications 528 generated by the application platform 510, as described in greater detail below.

In practice, the data 532 may be organized and formatted in any manner to support the application platform 510. In various embodiments, the data 532 is suitably organized into a relatively small number of large data tables to maintain a semi-amorphous “heap”-type format. The data 532 can then be organized as needed for a particular virtual application 528. In various embodiments, conventional data relationships are established using any number of pivot tables 534 that establish indexing, uniqueness, relationships between entities, and/or other aspects of conventional database organization as desired. Further data manipulation and report formatting is generally performed at run-time using a variety of metadata constructs. Metadata within a universal data directory (UDD) 536, for example, can be used to describe any number of forms, reports, workflows, user access privileges, business logic and other constructs that are common to multiple tenants. Tenant-specific formatting, functions and other constructs may be maintained as tenant-specific metadata 538 for each tenant, as desired. Rather than forcing the data 532 into an inflexible global structure that is common to all tenants and applications, the database 530 is organized to be relatively amorphous, with the pivot tables 534 and the metadata 538 providing additional structure on an as-needed basis. To that end, the application platform 510 suitably uses the pivot tables 534 and/or the metadata 538 to generate “virtual” components of the virtual applications 528 to logically obtain, process, and present the relatively amorphous data 532 from the database 530.

The server 502 may be implemented using one or more actual and/or virtual computing systems that collectively provide the dynamic application platform 510 for generating the virtual applications 528. For example, the server 502 may be implemented using a cluster of actual and/or virtual servers operating in conjunction with each other, typically in association with conventional network communications, cluster management, load balancing and other features as appropriate. The server 502 operates with any sort of conventional processing hardware 504, such as a processor 505, memory 506, input/output features 507 and the like. The input/output features 507 generally represent the interface(s) to networks (e.g., to the network 545, or any other local area, wide area or other network), mass storage, display devices, data entry devices and/or the like. The processor 505 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 506 represents any non-transitory short or long term storage or other computer-readable media capable of storing programming instructions for execution on the processor 505, including any sort of random access memory (RAM), read only memory (ROM), flash memory, magnetic or optical mass storage, and/or the like. The computer-executable programming instructions, when read and executed by the server 502 and/or processor 505, cause the server 502 and/or processor 505 to create, generate, or otherwise facilitate the application platform 510 and/or virtual applications 528 and perform one or more additional tasks, operations, functions, and/or processes described herein. It should be noted that the memory 506 represents one suitable implementation of such computer-readable media, and alternatively or additionally, the server 502 could receive and cooperate with external computer-readable media that is realized as a portable or mobile component or platform, e.g., a portable hard drive, a USB flash drive, an optical disc, or the like.

The application platform 510 is any sort of software application or other data processing engine that generates the virtual applications 528 that provide data and/or services to the client devices 540. In a typical embodiment, the application platform 510 gains access to processing resources, communications interfaces and other features of the processing hardware 504 using any sort of conventional or proprietary operating system 508. The virtual applications 528 are typically generated at run-time in response to input received from the client devices 540. For the illustrated embodiment, the application platform 510 includes a bulk data processing engine 512, a query generator 514, a search engine 516 that provides text indexing and other search functionality, and a runtime application generator 520. Each of these features may be implemented as a separate process or other module, and many equivalent embodiments could include different and/or additional features, components or other modules as desired.

The runtime application generator 520 dynamically builds and executes the virtual applications 528 in response to specific requests received from the client devices 540. The virtual applications 528 are typically constructed in accordance with the tenant-specific metadata 538, which describes the particular tables, reports, interfaces and/or other features of the particular application 528. In various embodiments, each virtual application 528 generates dynamic web content that can be served to a browser or other client program 542 associated with its client device 540, as appropriate.

The runtime application generator 520 suitably interacts with the query generator 514 to efficiently obtain multi-tenant data 532 from the database 530 as needed in response to input queries initiated or otherwise provided by users of the client devices 540. In a typical embodiment, the query generator 514 considers the identity of the user requesting a particular function (along with the user's associated tenant), and then builds and executes queries to the database 530 using system-wide metadata 536, tenant specific metadata 538, pivot tables 534, and/or any other available resources. The query generator 514 in this example therefore maintains security of the common database 530 by ensuring that queries are consistent with access privileges granted to the user and/or tenant that initiated the request.

With continued reference to FIG. 5, the data processing engine 512 performs bulk processing operations on the data 532 such as uploads or downloads, updates, online transaction processing, and/or the like. In many embodiments, less urgent bulk processing of the data 532 can be scheduled to occur as processing resources become available, thereby giving priority to more urgent data processing by the query generator 514, the search engine 516, the virtual applications 528, etc.

In exemplary embodiments, the application platform 510 is utilized to create and/or generate data-driven virtual applications 528 for the tenants that they support. Such virtual applications 528 may make use of interface features such as custom (or tenant-specific) screens 524, standard (or universal) screens 522 or the like. Any number of custom and/or standard objects 526 may also be available for integration into tenant-developed virtual applications 528. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system. The data 532 associated with each virtual application 528 is provided to the database 530, as appropriate, and stored until it is requested or is otherwise needed, along with the metadata 538 that describes the particular features (e.g., reports, tables, functions, objects, fields, formulas, code, etc.) of that particular virtual application 528. For example, a virtual application 528 may include a number of objects 526 accessible to a tenant, wherein for each object 526 accessible to the tenant, information pertaining to its object type along with values for various fields associated with that respective object type are maintained as metadata 538 in the database 530. In this regard, the object type defines the structure (e.g., the formatting, functions and other constructs) of each respective object 526 and the various fields associated therewith.

Still referring to FIG. 5, the data and services provided by the server 502 can be retrieved using any sort of personal computer, mobile telephone, tablet or other network-enabled client device 540 on the network 545. In an exemplary embodiment, the client device 540 includes a display device, such as a monitor, screen, or another conventional electronic display capable of graphically presenting data and/or information retrieved from the multi-tenant database 530, as described in greater detail below. Typically, the user operates a conventional browser application or other client program 542 executed by the client device 540 to contact the server 502 via the network 545 using a networking protocol, such as the hypertext transport protocol (HTTP) or the like. The user typically authenticates his or her identity to the server 502 to obtain a session identifier (“SessionID”) that identifies the user in subsequent communications with the server 502. When the identified user requests access to a virtual application 528, the runtime application generator 520 suitably creates the application at run time based upon the metadata 538, as appropriate. As noted above, the virtual application 528 may contain Java, ActiveX, or other content that can be presented using conventional client software running on the client device 540; other embodiments may simply provide dynamic web or other content that can be presented and viewed by the user, as desired. As described in greater detail below, the query generator 514 suitably obtains the requested subsets of data 532 from the database 530 as needed to populate the tables, reports or other features of the particular virtual application 528.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

“Node/Port”—As used herein, a “node” means any internal or external reference point, connection point, junction, signal line, conductive element, or the like, at which a given signal, logic level, voltage, data pattern, current, or quantity is present. Furthermore, two or more nodes may be realized by one physical element (and two or more signals can be multiplexed, modulated, or otherwise distinguished even though received or output at a common node). As used herein, a “port” means a node that is externally accessible via, for example, a physical connector, an input or output pin, a test probe, a bonding pad, or the like.

“Connected/Coupled”—The following description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, additional intervening elements, devices, features, or components may be present in an embodiment of the depicted subject matter.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, and other such numerical terms referring to structures do not imply a sequence or order unless clearly indicated by the context.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The various tasks performed may be performed by software, hardware, firmware, or any combination thereof. For illustrative purposes, the following description may refer to elements mentioned above. In practice, portions of the process may be performed by different elements of the described system, e.g., component A, component B, or component C. It should be appreciated that the process may include any number of additional or alternative tasks, the tasks need not be performed in the illustrated order, and the process may be incorporated into a more comprehensive procedure or process having additional functionality not described in detail herein. Moreover, one or more of the tasks could be omitted from an embodiment of the process as long as the intended overall functionality remains intact.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for navigating a modeling canvas used in software development, comprising:
accessing the modeling canvas at a starting active cell containing a node, where the modeling canvas contains a grid pattern arranged in rows and columns of cells;
receiving a keyboard initiated control command to indicate the selection of a new active cell containing a node;
executing the keyboard initiated control command to select a new active cell; and
generating an aural signal with a screen reader in response to the selection of the new active cell, where the aural signal communicates the contents of a label of the node within the new active cell to a user.

2. The method of claim 1, where the node within the new active cell comprises a user interface (UI) node.

3. The method of claim 1, where the node within the new active cell comprises a logic node.

4. The method of claim 1, where the node within the new active cell comprises a data node.

5. The method of claim 1, where the node within the new active cell comprises an action node.

6. The method of claim 1, where the keyboard initiated control command is in an navigation mode when selecting a new active cell, where the navigation mode authorizes a user to review details of each new active cell.

7. The method of claim 1, where the keyboard initiated control command is in an action mode when selecting a new active cell, where the action mode authorizes a user to edit details of each new active cell.

8. The method of claim 1, where the label of the node contains details of the node in text form.

9. The method of claim 8, where the text of the details of the node are partially hidden on the modeling canvas.

10. The method of claim 9, where the partially hidden text of the details of the node are fully displayed with a drop down menu.

11. The method of claim 9, where the contents partially hidden text of the details of the node are communicated with the aural signal from the screen reader.

12. The method of claim 1, where each active cell with a node contains an icon button for the node.

13. The method of claim 1, where each active cell with a node contains a delete command for the node.

14. The method of claim 1, where each active cell with a node contains a label, where the label of the node contains details of the node.

15. The method of claim 1, where each active cell with a node contains a command button to move to other active cells on the modeling canvas.

16. The method of claim 1, where the grid pattern arranged in rows and cells extends across multiple modeling canvasses, and where the multiple modeling canvasses are layered over each other so that a user may select active cells across different modeling canvasses with a keyboard initiated control command.

17. An apparatus for navigating a modeling canvas used in software development, comprising:
a processor;
a memory coupled to the processor, wherein the memory includes computer program instructions capable of:
accessing the modeling canvas at a starting active cell containing a node, where the modeling canvas contains a grid pattern arranged in rows and columns of cells;
receiving a keyboard initiated control command to indicate the selection of a new active cell containing a node;
executing the keyboard initiated control command to select a new active cell; and
generating an aural signal with a screen reader in response to the selection of the new active cell, where the aural signal communicates the contents of a label of the node within the new active cell to a user.
